(19) United States
(12) Patent Application Publication
(10) Pub. No.: US 2025/0252010 A1
(43) Pub. Date: Aug. 7, 2025

(54) METHOD AND DEVICE FOR ERROR DETECTION, IN PARTICULAR FOR ERROR CORRECTION, IN IN-MEMORY COMPUTATIONS

(71) Applicant: Robert Bosch GmbH, Stuttgart (DE)

(72) Inventors: Benjamin Hettwer, Kirchheim Unter Teck (DE); Jan Micha Borrmann, Mannheim (DE); Luca Parrini, Stuttgart (DE); Taha Soliman, Renningen (DE)

(21) Appl. No.: 19/032,519

(22) Filed: Jan. 21, 2025

(30) Foreign Application Priority Data
Feb. 1, 2024 (DE) 10 2024 200 934.2
Apr. 18, 2024 (DE) 10 2024 203 596.3

(51) Int. Cl. G06F 11/07

(52) U.S. Cl. CPC G06F 11/0793; G06F 11/0727; G06F 11/0751

(57) ABSTRACT

A method and a device for error detection, in particular for error correction, in in-memory computations with a set of memory cells for determining a result of a linear operation. Each respective memory cell in the set of memory cells includes a respective resistance. The device includes the set of memory cells and a memory cell for determining a checksum, that includes a resistance that is the same or essentially the same as the sum of the respective resistances.

### CROSS REFERENCE

The present application claims the benefit under 35 U.S.C. § 119 of Germany Patent Application Nos. DE 10 2024 200 934.2 filed on Feb. 1, 2024, and DE 10 2024 203 596.3 filed on Apr. 18, 2024, which are both expressly incorporated herein by reference in their entireties.

### FIELD

The present invention concerns a method and a device for error detection, in particular for error correction, in in-memory computations.

In memory computing comprises executing computations with data directly inside the memory itself. Error detection mechanisms for in memory computing such as hardware lockstep instead a duplication of all compute resources.

### SUMMARY

A device and method for error detection, in particular for error correction, in memory computing according to an example embodiment of the present invention provide a checksum mechanism that performs run-time error detection for a linear operation, e.g., a multiply and accumulate (MAC) arithmetic operation, by exploiting the linearity, e.g. of MAC arithmetic operations. This mechanism scales well with limited overhead.

According to an example embodiment of the present invention, the device is adapted for error detection, in particular for error correction, in in-memory computations with a set of memory cells for determining a result of a linear operation, wherein a respective memory cell in the set of memory cells comprises a respective resistance, wherein the device comprises the set of memory cells and at least one memory cell, in particular at least two memory cells, for determining a checksum, that comprises a resistance that is the same or essentially the same as the sum of the respective resistances. Thus, the output of the memory cell for determining the checksum is comparable to the sum of the outputs of the set of memory cells.

According to an example embodiment of the present invention, the device comprises a processing element, wherein the processing element comprises the set of memory cells and the at least one memory cell for determining the checksum. This means, the checksum for the linear operation, e.g. the MAC arithmetic operation, of a processing element is also determined in the processing element.

According to an example embodiment of the present invention, the resistances of the memory cells of the set of memory cells and the at least one memory cell for determining the checksum connect on one side of the respective resistance to a common input wire, and with the other side of the respective resistance to different output wires. This means, the error detection for the linear operation, e.g. the MAC arithmetic operation, of the set of memory cells that connect to the common input wire is determinable by, in particular at the time of, supplying the input wire with an input, determining a sum of the outputs of the set of memory cells and comparing the sum with the output of the memory cell that connects to the same input wire.

According to an example embodiment of the present invention, the device comprises a set of processing elements, wherein the at least one memory cell for determining the checksum is arranged in a different processing element of the set of processing elements than the set of memory cells. This means, the checksum for the linear operation, e.g. the MAC arithmetic operation, of a processing element is determined in a separate processing element.

According to an example embodiment of the present invention, the resistances of the memory cells of the set of memory cells connect on one side of the respective resistance to a common output wire, and on the other side of the respective resistance to different input wires. This means, the error detection for the linear operation, e.g. the MAC arithmetic operation, of the set of memory cells that connect to the common output wire is determinable by supplying the different input wires of the set of memory cells with a respective input and at a different time supplying the at least one memory cell for determining the checksum that connects to the same output wire with a sum of the respective input.

According to an example embodiment of the present invention, the resistances of the memory cells of the set of memory cells connect on one side of the respective resistance to a common output wire, and on the other side of the respective resistance to a common input wire.

According to an example embodiment of the present invention, the device comprises a controller that is configured to compare an output of the set of memory cells to the checksum, and to detect an error when the output and the checksum differ, wherein the device is configured to provide the output and the checksum to the controller.

For error correction, according to an example embodiment of the present invention, the device comprises a controller that is configured to add a difference between the output and the checksum to the output, when the error is detected. This means, the output of the set of memory cells is corrected with the difference.

According to an example embodiment of the present invention, the device comprises a processing element with a first part of a crossbar that comprises memory cells, and a processing element with a second part of the crossbar that comprises memory cells, wherein a first memory cell of the set of memory cells is arranged in the first part of the crossbar, wherein a second memory cell of the set of memory cells is arranged in the second part of the crossbar, wherein the device comprises an output adder, that is configured to add the output of the first memory cell and the second memory cell to the output of the set of memory cells. The output adder produces an output that can be verified against the checksum in an error detection in case the memory cells of the set of memory cells that are used for the linear operation, e.g. the MAC arithmetic operation are distributed in different processing elements.

According to an example embodiment of the present invention, the device comprises a processing element with a part of a first crossbar that comprises memory cells, and a processing element with a part of a second crossbar that comprises memory cells, wherein a first memory cell of the set of memory cells is arranged in the part of the first crossbar, wherein a second memory cell of the set of memory cells is arranged in the part of the second crossbar, wherein the device comprises an input adder, that is configured to add the input of the crossbars to an input for the memory cell for determining the checksum, and to provide the input to the memory cell for determining the checksum. The input adder produces an output that results in a checksum that can be used in an error detection in case the memory cells of the set of memory cells that are used for the linear operation, e.g. the MAC arithmetic operation, are distributed in different crossbars of different processing elements.

According to an example embodiment of the present invention, the set of memory cells and the at least one memory cell for determining the checksum are arranged in an arrangement of memory cells that comprises a processing element that comprises the set of memory cells and the at least one memory cell for determining the checksum, and a set of processing elements, and a further set of memory cells, and at least one further memory cell for determining the checksum for the further set of memory cells, wherein the at least one further memory cell is arranged in a different processing element of the set of processing elements than the further set of memory cells. This means, the further memory cell of determining the checksum is in a different processing element than the further set of memory cells it is used for in the error correction. The different processing element may be the same processing element that comprises the memory cell that is used for error correction of the set of memory cells or another processing element.

For error detection and correction, according to an example embodiment of the present invention, the device may comprise memory cells for determining two redundant checksums, and a memory cell for a parity check of the two redundant checksums, wherein the memory cell for determining the parity check comprises a resistance that is the same as the sum of the resistances of the memory cells that provide the least significant bits of the two redundant checksums.

According to an example embodiment of the present invention, the method for error detection, in particular for error correction, in in-memory computations with a set of memory cells for determining a result of a linear operation, wherein a respective memory cell in the set of memory cells comprises a respective resistance, comprises providing at least one memory cell, in particular at least two memory cells, for determining a checksum, that comprises a resistance that is the same or essentially the same as the sum of the respective resistances, determining a output of the set of memory cells and providing an input to the memory cell for determining the checksum, comparing the output to the checksum, and detecting an error in case the output and the checksum differ.

The following examples concern aspects of the present invention for providing an output of the at least one memory cell for determining the checksum and for determining the sum of the output of the set of memory cells that are used for the error detection.

According to an example embodiment of the present invention, the method comprises determining a respective output of a respective memory cell of the set of memory cells and the checksum resulting from providing the same input to the memory cells of the set of memory cells and the at least one memory cell for determining the checksum, and adding the respective output of the respective memory cells of the set of memory cells to the output.

According to an example embodiment of the present invention, the method comprises providing the memory cells of the set of memory cells with a respective voltage for determining a respective output of a respective memory cell of the set of memory cells, adding the respective output to the output, adding the respective input to an input for the at least one memory cell for determining the checksum, and providing the input to the memory cell for determining the checksum.

For error correction, the method may comprise adding the difference between the checksum and the output to the output, when the error is detected.

According to an example embodiment of the present invention, a first memory cell of the set of memory cells is associated with a first part of a crossbar in a first processing element, wherein a second memory cell of the set of memory cells is associated with a second part of the crossbar in a second processing element, wherein the output of the first memory cell and the second memory sell are added in the output of the set of memory cells.

According to an example embodiment of the present invention, a first memory cell of the set of memory cells is associated with a part of a first crossbar in a first processing element, wherein a second memory cell of the set of memory cells is associated with a part of a second crossbar in a second processing element, wherein the input of the crossbars are added to the input for the at least one memory cell for determining the checksum.

According to an example embodiment of the present invention, for error detection and correction, the method may comprise checking a parity of memory cells for determining two redundant checksums, with a memory cell for a parity check of the two redundant checksums, wherein the memory cell for determining the parity check comprises a resistance that is the same as the sum of the resistances of the memory cells that provide the least significant bits of the two redundant checksums, recomputing the checksums in case the parity check fails, and correcting an error indicated by the two redundant checksums otherwise.

Further advantageous embodiments of the present invention are derivable from the following description and the figures.

### BRIEF DESCRIPTION OF THE DRAWINGS

FIG. 1 schematically depicts a device for in memory computing, according to an example embodiment of the present invention.

FIG. 2 schematically depicts processing elements with a channel checksum adder unit, according to an example embodiment of the present invention.

FIG. 3 depicts a flow-chart comprising steps of a first exemplary method for error detection, according to an example embodiment of the present invention.

FIG. 4 schematically depicts processing elements with an additional row of processing elements, according to an example embodiment of the present invention.

FIG. 5 depicts a flow-chart comprising steps of a first version of a second exemplary method for error detection, according to the present invention.

FIG. 6 schematically depicts processing elements with an additional column of processing elements, according to an example embodiment of the present invention.

FIG. 7 depicts a flow-chart comprising steps of a second version of the second exemplary method for error detection, according to the present invention.

FIG. 8 depicts a flow-chart comprising steps of a method for error correction, according to an example embodiment of the present invention.

FIG. 9 schematically depicts processing elements with crossbar checksums and a processing element with a parity column, according to an example embodiment of the present invention.

FIG. 10 depicts a flow-chart comprising steps of a method for error detection and correction, according to ane example embodiment of the present invention.

### DETAILED DESCRIPTION OF EXAMPLE EMBODIMENTS

In-Memory-Computing, IMC, comprises executing computation with the data directly inside a memory.

The following description concerns a hardware safety mechanism that helps to provide a reliable execution of the IMC.

According to some examples, errors occurring during the computation are detected. According to some examples, errors that are detected are also corrected.

The IMC may be used for determining a result of a linear operation. An example of a linear operation is a multiply and accumulate (MAC) arithmetic operation.

According to an example, the memory comprises a regular grid of memory cells that stores parameters of one linear operation or more linear operations, e.g. the MAC arithmetic operations to be executed as a respective resistive value.

For example, the IMC of MAC is used for determining a prediction of a neural network that comprises MAC arithmetic operations to map input data of the neural network to a prediction depending on parameters of the neural network. An MAC arithmetic operation of the neural network of the neural network may be implemented in a hardware accelerator, wherein the parameters of the MAC arithmetic operation define the resistive values in the grid.

The neural network is for example used in a deep learning algorithm. The neural network is for example employed in the automotive field. The neural network is for example configured to output a classification that represents an object of a set of detectable objects. The neural network is for example configured to output the classification depending on input data that represents a digital image.

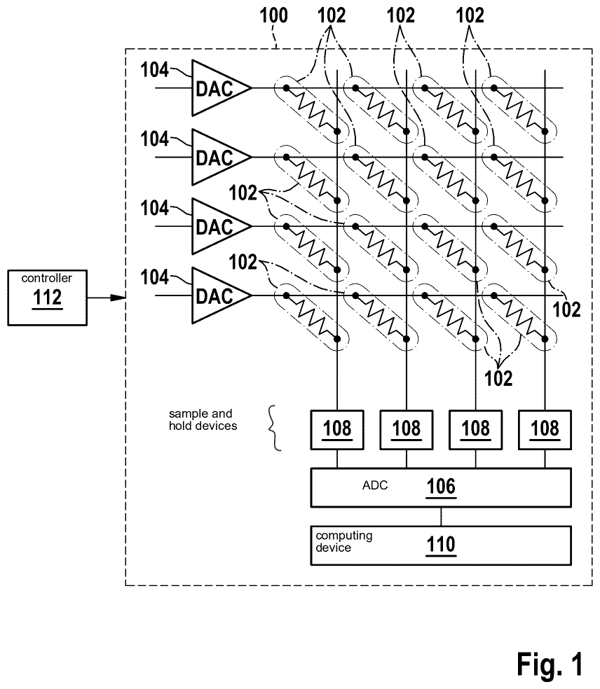

FIG. 1 schematically depicts a device 100 for IMC.

The device 100 comprises a grid of memory cells 102. The memory cells 102 within a same column and row in the grid share respectively a vertical and horizontal wire.

FIG. 1 depicts an example for N=4 rows and M=4 columns. The grid is not limited to 4 rows and 4 columns. The grid may comprise more than 4 rows and more than 4 columns.

This means, the device comprises a part of a crossbar scheme, wherein a crossbar comprises the memory cells 102 that are connected by the same wire in the same row. The memory cells 102 comprise a resistance. According to an example, the respective resistance G_{c} is programmed according to respective parameter of the linear operation, e.g. the MAC arithmetic operation.

The IMC is generalized in the following way:

A digital input is converted to a signal in the analogue domain, i.e. an input voltage Vᵢ, using a digital to analogue converter, DAC, 104. In the example, a respective input voltage V_{i,n} is provided by one DAC 104 to one of the crossbars. The digital input for example represents an input operand of the linear operation, e.g. of the MAC arithmetic operation.

The analogue signals are applied and propagated to each row inside the grid that contains the programmed memory cell 102.

Using Ohm's law, an output current I_{c} of the respective memory cell 102 is determined, i.e. the product is performed between the analog inputs and the resistance values stored in the respective programmed memory cell 102.

I_{c}=VᵢG_{c}

Using Kirchhoff's law, the output currents I_{c} of N rows are summed together to an output current Iₒ in the M columns

$${I}_{o , m} = {\sum }_{n = 1}^{N} {I}_{c , n} , m = 1 , … M$$

The output current I_{o,m} of a column is converted back to the digital domain using an analog to digital converter, ADC, 106. In the example, a respective sampling and hold device 108 is provided for a respective column. The sampling and hold device 108 is configured to sample and hold the output current I_{o,m} of the respective column. In the example, the ADC 106 is configured to process the output currents I_{o,m} available in the sampling and hold devices 108.

The device 100 comprises a computing device 110 that is configured to determine a digital result of the linear operation, e.g. the MAC arithmetic operation, depending on the digital output of the ADC 106. In the example, the computing device 110 is configured to shift the digital output of the ADC 106.

According to an example, the DACs 102 are controllable to output the respective input voltage V_{i,n} to the respective rows and the sampling and hold devices 108 are controllable to sample and hold the output currents I_{o,m} of the respective columns coordinated by a controller 112. The controller 112 is for example configured to trigger the DACs 102 provide the input voltage V_{i,n} to the respective rows and to trigger the sampling and hold devices 108 to sample and hold the respective output currents I_{o,m} according to the linear operation, e.g. the MAC arithmetic operation, that the device 100 implements.

The linear operation, e.g. the MAC arithmetic operation, may be a sub-part of a computation.

Logically, sub-arrays of the grid can be regarded as individual Processing Elements, PE. A PE comprises per row a part of the crossbar, i.e. a part of the memory cells 102 of the row. The PEs are for example configured for performing, in particular in parallel, sub-parts of the computation.

The resistances may have resistance values that correspond to values of the parameters. The parameters may represent weights of the neural network.

The input voltages Vin may have values that correspond to activation values of the neural network.

The device 100 may be exploited then, to accelerate the linear operation, e.g. the MAC arithmetic operation, in particular in a neuron of the neural network.

For error detection, a checksum mechanism is implemented at least partially in hardware.

### First Example

According to the first example, the checksum mechanism comprises a channel checksum adder unit O^{ccadd}. According to a second example, the checksum mechanism comprises a batch checksum adder unit O^{bcadd}.

In the following equations the x variable correspond to the inputs, the w variable
correspond to the stored weights, n is the PE index, c is the index of the column of each grid inside each PE, k is the index of the row of each grid inside each PE.

According to the first example, the checksum for a PE block is implemented inside the PE block. According to the first example, the PE block comprises an additional column O^{Wadd} which comprises the resistances with values corresponding to the sum of the resistances that represent the parameters of the rows in the part of the crossbar of the PE.

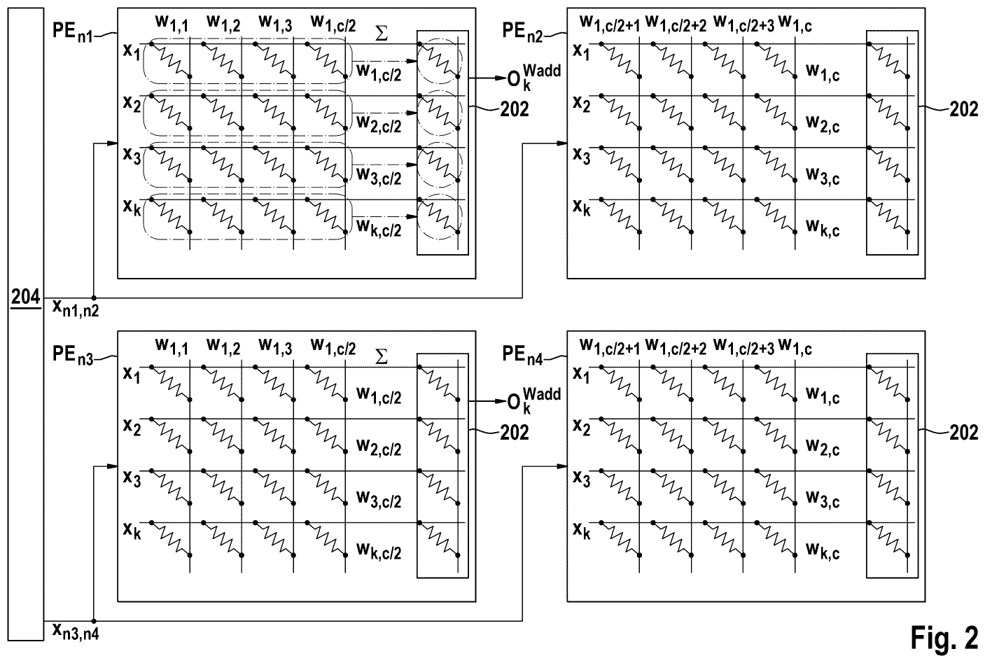

FIG. 2 schematically depicts four exemplary PEs, a first PEₙ₁, a second PEₙ₂ a third PEₙ₃ and a fourth PEₙ₄. comprising a respective channel checksum adder unit 202. In the example, the channel checksum adder unit 202 comprises a respective last column of the four exemplary PEs.

The PEs respectively comprise k rows with a respective input x₁, x₂, x₃, . . . , xₖ. The PEs respectively comprise c/2 columns for the linear operation, e.g. the MAC arithmetic operation, and one column for parts of the checksum. In the example, the value of the resistance, i.e. the weight, of the memory cell in the column for the checksum values of a respective PE is the sum of the values of the resistances, i.e. the weights, of the other memory cells of the respective PE that are in the same row, as the memory cell in the column for the checksum.

According to an example, the weights of the first PEₙ₁ are w_{1,1}, w_{1,2}, w_{1,3}, . . . , w_{k,c/2}. According to an example, the weights of the second PEₙ₂ are w_{1,c/2+1}, w_{1,2}, w_{1,3}, . . . , w_{k,c}. According to an example, the weights of the third PEₙ₃ are w_{1,1}, w_{1,2}, w_{1,3}, . . . , w_{k,c/2}. According to an example, the weights of the fourth PEₙ₄ are w_{1,c/2+1}, w_{1,2}, w_{1,3}, . . . , w_{k,c}.

The value of the weights is programmed according to the linear operation, e.g. the MAC arithmetic operation, in particular the weights of the part of the neural network, that the respective PE represents.

According to the first example, an input buffer 204 is configured to provide a first input xₙ_{₁}=x₁, . . . , x₄ to the first PEₙ₁, a second input xₙ_{₂}=x₁, . . . , x₄ to the second PEₙ₂, a third input xₙ_{₃}=x₁, . . . , x₄ to the third PEₙ₃, a fourth input xₙ_{₄}=x₁, . . . , x₄ to the fourth PEₙ₄. The values of the first input xₙ_{₁} the second input xₙ_{₂}, the third input xₙ_{₃}, and the fourth input xₙ_{₄} are determined by the operands of the respective linear operation, e.g. the MAC arithmetic operation, in particular the input of the part of the neural network, that the respective PE represents.

The output of a column corresponds to the result of a single linear operation, e.g. a single MAC arithmetic operation, in particular within a neuron, inside a single PE.

The checksum

O^{ccpe}=Σₖx_{k,n}Oₖ^{Wadd}

results from the same inputs being fed to the additional linear operation in the last row of the respective PEs.

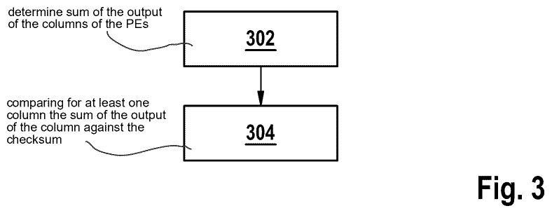

FIG. 3 depicts a first example of a method for error detection.

The method according to the first example comprises a step 302.

The step 302 comprises determining a sum of the output of the columns of the PEs in response to providing the respective input to the respective PE.

The step 302 comprises determining, for the respective column n, a checksum Oₙ^{ccpe} in response to providing the respective input to the respective PE.

The method according to the first example comprises a step 304.

The step 304 comprises comparing for at least one column n the sum of the output of the column n of the PEs against the checksum Oₙ^{ccpe} for the column n.

If the n the sum of the output of the column n of the PEs against the checksum Oₙ^{ccpe} match, the computation was correctly executed, otherwise a fault either in the sum for the column, i.e. the crossbar, or in the checksum Oₙ^{ccpe} for the column n occurred.

This error detection is based on the following:

$${O}_{n}^{ccadd} = {\sum }_{c} {O}_{c , n} = {\sum }_{c} {\sum }_{k} {x}_{k , n} {w}_{c , k} = {\sum }_{k} {x}_{k , n} {\sum }_{w} {w}_{c , k} = {\sum }_{k} {x}_{k , n} {O}^{Wadd} = {O}_{n}^{ccpe}$$

### Second Example

The second example is described by way of example of a first version and a second version, that differ by the way parameters of the linear operation, e.g. the MAC arithmetic operation, are reused.

The checksum mechanism according to the first version reuses the resistances, i.e. the weights, within the same column of the respective PEs. The checksum mechanism comprises an additional row of PEs that contains the sum of resistances, i.e. the sum of the values of the weights, stored inside the respective column of PEs.

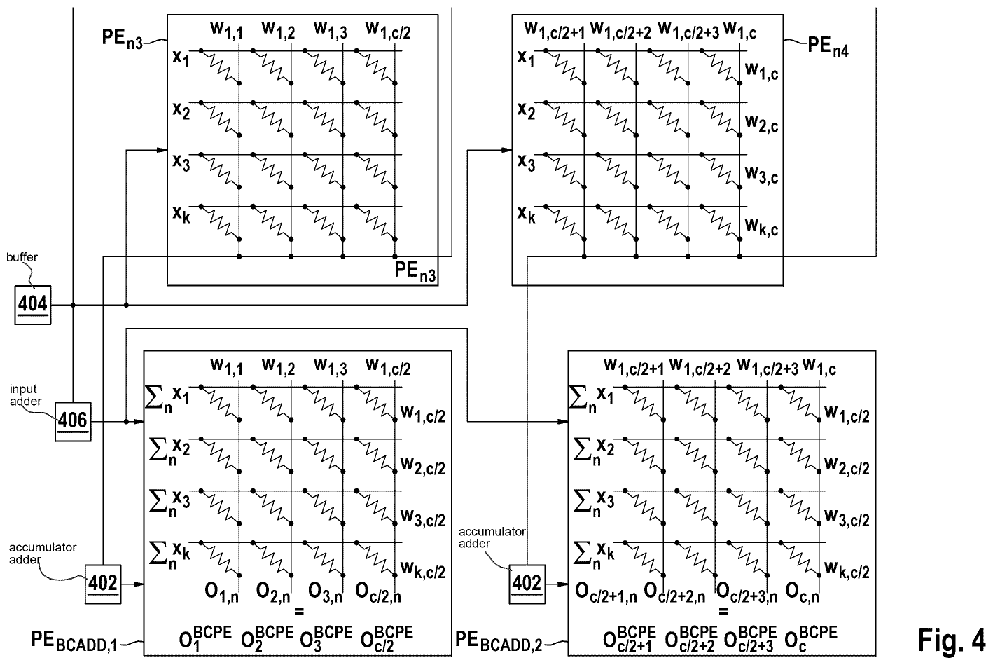

FIG. 4 schematically depicts a part of the respective PEs, of a set of four PEs comprising a first PEₙ₁, a second PEₙ₂ a third PEₙ₃ and a fourth PEₙ₄, wherein the additional row comprises a first additional PE_{BCADD,1}, and a second additional PE_{BCADD,2}. The first PEₙ₁, the third PEₙ₃ and the first additional PE_{BCADD,1} are arranged in the same column. The second PEₙ₂, the fourth PEₙ₄, and the second additional PE_{BCADD,2} are arranged in the same column.

The first version of the checksum mechanism according to the second example is not limited to four PEs and two additional PEs. According to the first version, more than two columns and more than two rows of PEs may be provided.

According to the first version, the checksum mechanism comprises in the first column and in the second column a respective accumulator adder 402.

The respective accumulator adder 402 is configured to add the outputs of each crossbar from different PEs within the same column maintaining the same indexes. The accumulator adders 402 respectively obtain a vector of values corresponding to the accumulated results of each column from the different crossbars. According to an example with c columns of memory cells, the accumulator adder 402 for the first column of PEs is configured to output O₁^{BCPE}, O₂^{BCPE}, O₃^{BCPE}, O_{c/2}^{BCPE} and the accumulator adder 402 for the second column of PEs is configured to output O_{c/2+1}^{BCPE}, O_{c/2+2}^{BCPE}, O_{c/2+3}^{BCPE}, O_{c/2+4}^{BCPE}

According to the first version, the checksum mechanism comprises a buffer 404 that is configured to provide a respective input to a respective PE.

The buffer 404 in the example is configured to provide the respective input to the respective PE as described for the buffer 204 and the PEs according to the first example.

According to an example with k rows and c columns of memory cells, the resistances, i.e. the weights of the first PEₙ₁ are w_{1,1}, w_{1,2}, w_{1,3}, . . . , w_{k,c/2}. According to an example, the resistances, i.e. the weights of the second PEₙ₂ are w_{1,c/2+1}, w_{1,2}, w_{1,3}, . . . , w_{k,c}. According to an example, the resistances, i.e. the weights of the third PEₙ₃ are w_{1,1}, w_{1,2}, w_{1,3}, . . . , w_{k,c/2}. According to an example, the resistances, i.e. the weights of the fourth PEₙ₄ are w_{1,c/2+1}, w_{1,2}, w_{1,3}, . . . , w_{k,c}.

According to the example with k rows and c columns of memory cells, the resistances, i.e. the weights of the first additional PE_{BCADD,1} are w_{1,1}, w_{1,2}, w_{1,3}, . . . , w_{k,c/2}. According to an example, the resistances, i.e. the weights of the second PE_{BCADD,2} are w_{1,c/2+1}, w_{1,2}, w_{1,3}, . . . , w_{k,c}.

The columns of memory cells of the first additional PE_{BCADD,1} in the example output a respective checksum O_{1,n}, O_{2,n}, O_{3,n}, . . . , O_{c/2,n}. The columns of memory cells of the second additional PE_{BCADD,2} in the example output a respective checksum O_{c/2+1,n}, O_{c/2+2,n}, O_{c/2+3,n}, . . . , O_{c,n}

According to the first version, the checksum mechanism comprises an input adder 406.

The input adder 404 is configured to add together the input values that are fed to each row of PEs, maintaining the same crossbars' row indexes. The input adder 404 is configured to add the input values to a second vector O_{Iadd} with values corresponding to the accumulated inputs given to the different rows of the PEs.

The input adder 404 according to the example comprising k rows of memory cells is configured to add n input values for one additional PE to the vector O_{Iadd} for the additional PE:

Σₙx₁, Σₙx₂, Σₙx₃, . . . , Σₙxₖ

According to the first version, the checksum mechanism comprises providing the second vector O^{Iadd} to the additional row that contains the same parameters of the ones from the same column of PEs:

O_{c}^{BCPE}ΣₖOₖ^{Iadd}w_{c,k}

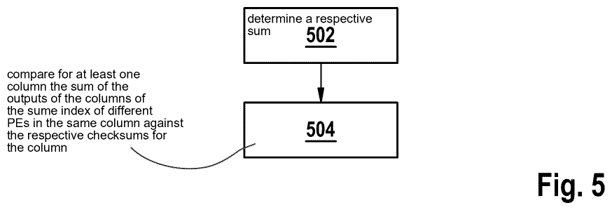

FIG. 5 depicts a first variant of a second example of a method for error detection.

The method according to the first variant of the second example comprises a step 502.

The step 502 comprises determining, in particular with the input adder 406, a respective sum Σₙxᵢ of the input for the rows i of the additional PEs.

The step 502 comprises determining the respective checksums O_{1,n}, O_{2,n}, O_{3,n}, O_{4/2,n}, O_{c/2+1,n}, O_{c/2+2,n}, O_{c/2+3,n}, O_{c/2+4,n}.

The step 502 comprises determining, in particular with the accumulator adder 402, a sum Oⱼ^{BCPE} of the outputs of the columns j of the same index of different PEs in the same column of PEs in response to providing the respective input to the respective PEs.

The method according to the first variant of the second example comprises a step 504.

The step 504 comprises comparing for at least one column j the sum Oⱼ^{BCPE} of the outputs of the columns j of the same index of different PEs in the same column of PEs against the respective checksums O_{j,n}, for the column j.

If the sum Oⱼ^{BCPE} of the outputs of the columns j of the same index of different PEs in the same column of PEs matches the respective checksums O_{j,n} for the column j, the computation for the column j was correctly executed, otherwise an error occurred in either the checksum O_{j,n} or the sum Oⱼ^{BCPE}. If the sum Oⱼ^{BCPE} of the outputs of one column j fails to match the respective checksums O_{j,n} for the column j, the computation for that column j was incorrectly executed. In case the sum Oⱼ^{BCPE} matches checksums O_{j,n} for the c columns of memory cells, the entire calculation is correct. Otherwise an error occurred.

This error detection is based on the following:

$${O}_{c}^{b c a d d} = {\sum }_{n} {O}_{c , n} = {\sum }_{c} {\sum }_{k} {x}_{k , n} {w}_{c , k} = {\sum }_{k} {\sum }_{n} {x}_{k , n} {w}_{c , k} = {\sum }_{k} {O}_{k}^{Iadd} {w}_{c , k} = {O}_{c}^{bcpe}$$

According to the second version of the second example the inputs are reuse
within the same row of PEs.

The checksum mechanism according to the second version is configured with additional PEs as described for the first version, whereas the additional PEs are provided in an additional column instead of in an additional row.

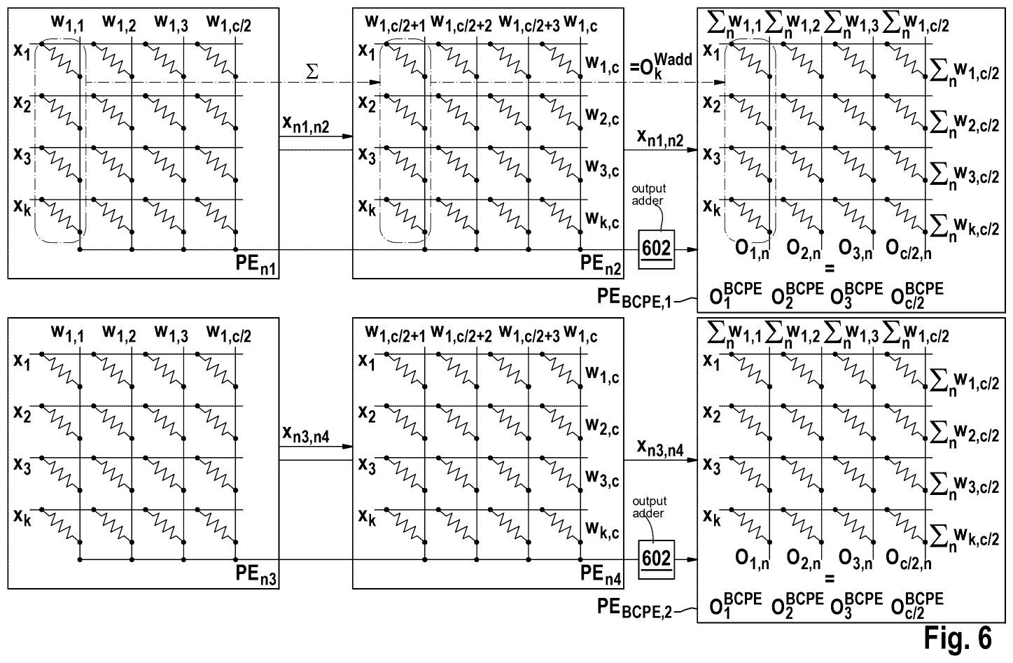

FIG. 6 schematically depicts the four PEs with an additional column of processing elements. The first PEₙ₁, the second PEₙ₂ and the first additional PE_{BCADD,1} are arranged in the same row. The third PEₙ₂, the fourth PEₙ₄, and the second additional PE_{BCADD,2} are arranged in the same row.

In contrast to the first version, the additional PEs according to the second version comprise the resistances, i.e. the weights that are programmed with a sum Oₖ^{Wadd} of the resistances, i.e. the weights stored within the same column's index of the crossbars that are part of the respective row of the PEs.

This error detection is based on the same consideration as the first version, applied to the resistances, i.e. the weights of different PEs.

The resistance, i.e. the weight w_{i,j} of a row i and a column j in the additional PEs is the sum of the resistances, i.e. the resistances, i.e. the weights in the same row i and column j of the n PEs:

$${\sum }_{n} {w}_{i , j}$$

The first additional PE_{BCPE,1} is configured to output for the first row of PEs checksums

O_{1,n}, O_{2,n}, O_{3,n}, . . . , O_{c/2,n}

The second additional PE_{BCPE,2} is configured to output for the second row of PEs checksums

O_{1,n}, O_{2,n}, O_{3,n}, . . . , O_{c/2,n}

According to the second version, the set of inputs from a respective row of PEs is fed to the respective PE belonging to the respective additional column.

According to the second version, the checksum mechanism comprises for the rows a respective output adder 602, that is configured to add the outputs of the crossbars from different PEs within the same row j maintaining the same indexes. The output adder 602 of a row j of PEs is configured to output a vector comprising the sums for the row j:

O₁^{BCPE}, O₂^{BCPE}, O₃^{BCPE}, . . . , O_{c/2}^{BCPE}

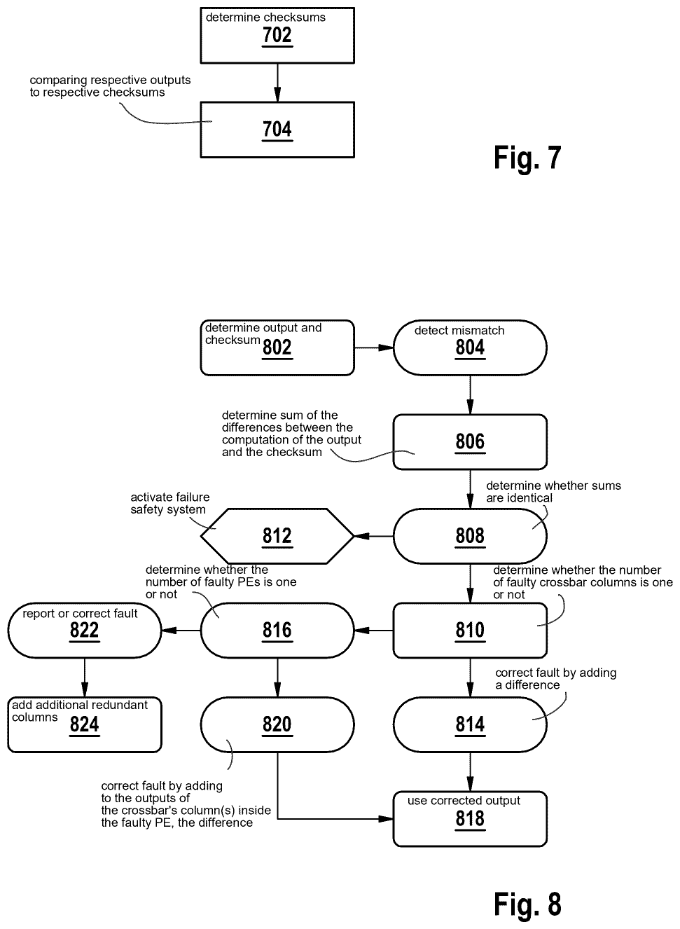

FIG. 7 depicts a flow-chart comprising steps of a second version of the second exemplary method for error detection.

The method according to the second variant of the second example comprises a step 702.

The step 702 comprises determining the checksums, in particular as the output of the column i of memory cells of the additional PE j for the respective row j

O_{i,j}

in response to providing the corresponding input the respective additional PEs.

The step 702 comprises determining, in particular with the respective output adder 602, for the respective row j the sums) O_{i,j}^{BCPE}.

The method according to the second variant of the second example comprises a step 704.

The step 704 comprises comparing the respective outputs O_{i,j}^{BCPE} to the respective checksums O_{i,j}.

If the respective outputs O_{i,j}^{BCPE} match the respective checksums O_{i,j}. the computation was correctly executed, otherwise an error occurred in either a checksum O_{j,j} or a sum O_{i,j}^{BCPE}.

FIG. 8 schematically depicts a flow-chart comprising a method for error correction. The method for error correction is based on the methods for error correction according to the first example and the second example.

The method for error correction comprises a step 802.

The step 802 comprises determining the output O_{c} and the checksum O_{BCPE,c} according to the first example of the method for error detection and the output Oₙ and the checksum O_{n,CCPE} according to the second example of the method for error detection.

The method for error correction comprises a step 804.

The step 804 comprises detecting a mismatch in the computation of at least one crossbars' column.

The method for error correction comprises a step 806.

The step 806 comprises determining the sum

$${O}_{c , BCADD} = \sum ( {O}_{BCPE , c} - {O}_{c} )$$

of the differences between the computation of the output O_{c} and the checksum O_{BCPE,c} for the output O_{c} and the sum

$${O}_{n , CCADD} = \sum ( {O}_{n , BCPE} - {O}_{n} )$$

of the differences between the computation of the output Oₙ and the checksum O_{n,BCPE} the output Oₙ.

The method for error correction comprises a step 808.

The step 808 comprises determining whether the sums O_{c,BCADD} and O_{n,CCADD} is identical. In case the sums match, i.e. O_{c,BCADD}==O_{n,CCADD}, a step 810 is executed.

Otherwise, a failure safety system is activated in a step 812.

In case the sums match, a fault occurred during the original computation and not during computation of one of the two checksums.

The indexes of the two checksums provide coordinates to identify in which crossbar column or in which crossbar columns of which PE or of which PEs a fault occurred.

According to the first version of the second example of the method for error detection, the index n of O_{n,BCADD} corresponds to the row of a matrix of the PEs and the index c of O_{c,BCADD} corresponds to the column of the grid inside the respective PE.

According to the second version of the second example of the method for error detection, the index n of O_{n,BCADD} corresponds to the column of a matrix of the PEs and the index c of O_{c,BCADD} corresponds to the column of the grid inside the respective PE.

In the step 810 it is determined whether the number of faulty crossbar columns is one or not. In case the number of faulty crossbar columns is one, a step 814 is executed. Otherwise a step 816 is executed.

In the step 814, the fault is corrected by adding a difference Δ. For example, for faulty output Oₙ₁^{fault} of the first PEₙ₁ the corrected output Oₙ₁^{corrected} of the first PEₙ₁ is determined. For example for faulty output Oₙ₂^{fault} of the second PEₙ₂ the corrected output Oₙ₂^{corrected} of the second PEₙ₂ is determined. An example for determining the corrected output is:

$${O}_{c}^{BCADD} = {O}_{c}^{BCPE} - {O}_{c} = Δ ( {O}_{n 1} , {O}_{n 1}^{fault} ) + Δ ( {O}_{n 2} , {O}_{n 2}^{fault} )$$

$${O}_{n 1}^{BCADD} = {O}_{n 1}^{C C P E} - {O}_{n 1} = Δ ( {O}_{n 1} , {O}_{n 1}^{fault} )$$

$${O}_{n 2}^{BCADD} = {O}_{n 2}^{C C P E} - {O}_{n 2} = Δ ( {O}_{n 2} , {O}_{n 2}^{fault} )$$

$${O}_{n 1}^{c o r rected} := {O}_{n 1} + {O}_{n 1}^{CCADD}$$

$${O}_{n 2}^{c o r rected} := {O}_{n 2} + {O}_{n 2}^{CCADD}$$

After Step 814 a step 818 is executed.

In the step 818, the corrected output is used, e.g. to determine the prediction of the neural network.

The step 816 comprises determining whether the number of faulty PEs is one or not. In case the number of faulty PEs is one, a step 820 is executed. Otherwise a step 822 is executed.

In step 820, the fault is corrected by adding to the outputs of the crossbar's column(s) inside the single faulty PE, the difference Δ computed for the O_{c}^{BCADD}
of the corresponding column or of the corresponding columns of the single faulty PE.

In this case according to the first version of the second example, the difference Δ calculated for a single column, corresponds to the error occurring inside the specific PE belonging to the n-th row of the matrix of PEs.

In this case according to the second version of the second example, the difference Δ calculated for a single column, corresponds to the error occurring inside the specific PE belonging to the n-th column of the matrix of PEs.

An example for determining the corrected output is:

$${O}_{n}^{CCADD} = {O}_{n}^{CCPE} - {O}_{n} = Δ ( {O}_{c 1} , {O}_{c 1}^{fault} ) + Δ ( {O}_{c 2} , {O}_{c 2}^{fault} )$$

$${O}_{c 1}^{BCADD} = {O}_{c 1}^{CCPE} - {O}_{c 1} = Δ ( {O}_{c 1} , {O}_{c 1}^{fault} )$$

$${O}_{c 2}^{BCADD} = {O}_{c 2}^{CCPE} - {O}_{c 2} = Δ ( {O}_{c 2} , {O}_{c 2}^{fault} )$$

$${O}_{c 1}^{c o r rected} := {O}_{c 1} + {O}_{c 1}^{BCADD}$$

$${O}_{c 2}^{c o r rected} := {O}_{c 2} + {O}_{c 2}^{BCADD}$$

After the step 820, the step 818 is executed.

In step 822 the fault may be reported or corrected with a different method.

For example, the computation may be repeated.

Optionally, a step 824 may be executed. In the step 824 additional redundant columns may be added.

Then the computation may be repeated with the additional redundant columns.

The additional redundant columns may be uses instead of the faulty cells inside the crossbars.

In case the two versions of the second example are implemented at the same time, the same steps of the method for error correction may be repeated, to improve the fault correction coverage of the method for error correction.

The choice of the version of the second example may be based on the cost of additional hardware. The choice may be done on a case-by-case basis according to a structure of the hardware accelerator, in order to obtain an optimal trade-off between error correction capability and area overhead.

The method for error correction is able to cope with random or unintentional hardware faults. The method for error correction is able to detect correct bit-flips that has been maliciously introduced by an adversary.

Fault injection attacks in volatile or non-volatile memory can be induced, e.g., through extensive writing process to neighboring memory cells which generates a thermal crosstalk.

According to an example, the device 100 is configured to provide the output and the checksum to the controller.

According to an example, the controller 112 is configured to execute the methods.

The controller 112 is for example configured to compare an output of the set of memory cells 102 to the checksum, and to detect an error when the output and the checksum differ.

According to an example, the controller 112 is configured to add the difference Δ to the output, when the error is detected.

The input adder 406 may be a digital adder that is configured to add the inputs that the controller 112 determines for the respective PEs digitally. The input adder 406 may be configured to trigger the DAC of the PE comprising the memory cells 102 for determining the checksum to output an input voltage according to the sum of the inputs.

The output adder 602 may be a digital adder that is configured to receive the respective outputs digitally and to add the outputs digitally.

The accumulator adder 402 may be a digital adder that is configured to receive the respective outputs and add the outputs digitally.

In principle, these adders may be analogue adders and the output of these adders may be analogue as well.

In the following, in a method for error detection and correction, errors are considered in a scenario in which an error in the calculation of one of two redundant checksum crossbars occurs, or in a scenario in which multiple errors simultaneously occur in more crossbars' columns belonging to different PEs.

If the values of two redundant checksums differ, the method for error detection and correction may comprise a stall. During the stall, at least one of the checksums is repeatedly determined until the values of the two checksums match. This mitigates errors caused by transient faults.

If multiple errors in more crossbars' columns belonging to different PEs are detected, the method for error detection and correction may comprise a stall. During the stall, at least on output or at least one checksum that caused at least one of the multiple errors is repeatedly determined until only one or no error is detected. This allows a faulty logic that leads to the multiple errors to recompute the results and mitigate the presence of errors caused by transient faults.

According to the example, the checksum values described above are calculated in an original design.

The method for error detection and correction may comprise an additional cycle for recalculating the checksum values in the following two cases.

### Consecutive MAC Recomputations:

After calculating a fixed number of consecutive stalls in the original design, an additional cycle to recompute the checksums is introduced.

The fixed number may be preset or the method may comprise determining the fixed number from input of a hardware designer. This allows the hardware designer to preset or select the fixet number according to the technology being tested.

### Parity Check:

A parity column may be used. According to an example, the parity column comprises an additional column of memory cells programmed, e.g., with the parity codes of the Hamming Weights' values mapped inside the redundant checksum crossbars. The parity check is for example:

$${\sum }^{i} {O}_{i , b}^{P E c h} \%2 == {O}_{b}^{P a r} \%2$$

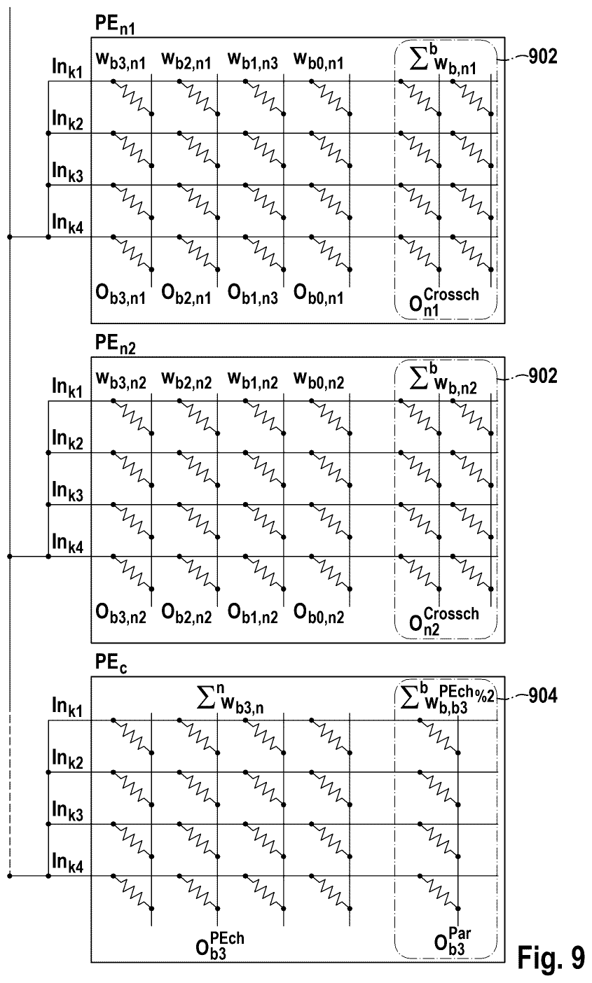

FIG. 9 schematically depicts a exemplary PEs with redundant crossbar checksum adder units 902. FIG. 9 depicts a first PEₙ₁ and a second PEₙ₂ with a respective redundant crossbar checksum adder unit 902. FIG. 9 schematically depicts an exemplary PE_{c} with a parity unit 904.

In the example, the redundant crossbar checksum adder unit 902 comprises the last two columns of the respective PE with redundant crossbar checksum adder units 902.

In the example, the parity unit 904 comprises the last column of the PE_{c}.

The PEs respectively comprise 4 rows with a respective input Ink₁, Ink₂, Ink₃, Ink₄. The first PEₙ₁ and second PEₙ₂ respectively comprise 4 columns for the linear operation, e.g. the MAC arithmetic operation, and two columns for parts of the checksum. In the example, the value of the resistance, i.e. the weight, of the memory cell in the column for the checksum values of a respective PE is the sum of the values of the resistances, i.e. the weights, of the other memory cells of the respective PE that are in the same row, as the memory cell in the column for the checksum.

According to an example, the weights of the first PEₙ₁ are w_{b3/n1}, w_{b2,n1}, w_{b1,n1}, w_{b0,n1}. According to an example, the weights of the second PEₙ₂ are w_{b3/n2}, w_{b2,n2}, w_{b1,n2}, w_{b0,n2}.

The value of the weights is programmed according to the linear operation, e.g. the MAC arithmetic operation, in particular the weights of the part of the neural network, that the respective PE represents.

The output of a column corresponds to the result of a single linear operation, e.g. a single MAC arithmetic operation, in particular within a neuron, inside a single PE.

The output of the first to fourth column of the first PEₙ₁ is O_{b3,n1}, O_{b2,n1}, O_{b1,n1}, O_{b0,n1}

The crossbar checksum in the first PEₙ₁ is

O^{b}=Σ^{b}w_{b,n1}

The output of the first to fourth column of the second PEₙ₂ is O_{b3,n2}, O_{b2,n2}, O_{b1,n2}, O_{b0,n2}

The crossbar checksum in the second PEₙ₂ is

O_{b}=Σ^{b}w_{b,n2}

According to an example, the memory cells in the PE_{c}, i.e., the weights of the are Σⁿw_{b,n}

The output of the parity column, i.e., the parity unit 904 in the PE_{c} is

$${O}^{b} = {\sum }^{b} {W}_{b , b 3}^{PEch} \%2$$

The output of the first to forth column of the PE_{c} is

O_{b3}^{PEch}

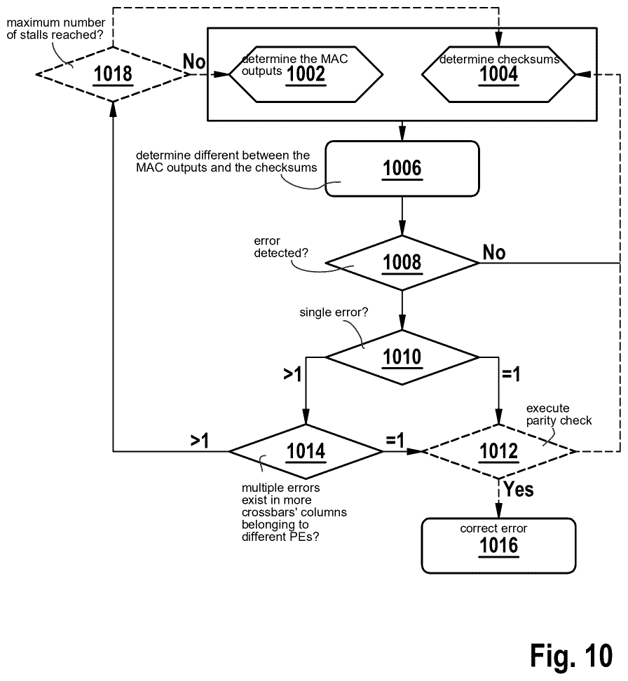

FIG. 10 depicts a flow-chart comprising steps of a method for error detection and correction.

The method comprises a step 1002.

In the step 1002, the MAC outputs are determined.

The method comprises a step 1004.

In the step 1004, the checksums are determined. The checksums are determined for predetermined MAC outputs. The checksums are associated with the MAC output that they are determined for.

The method comprises a step 1006.

In the step 1006, differences between the MAC outputs and the checksums that they are associated with are determined.

The method comprises a step 1008.

In the step 1008, it is determined whether an error is detected or not. An error is for example detected, in case a difference between a checksum and a MAC output that the checksum is associated with, exists or exceeds a predetermined threshold. No error is detected for example, if no difference exists between the checksums and the MAC outputs the respective checksum is associated with.

In case that no error exists, the step 1002 is executed for new MAC output.

In case that at least one error is detected, a step 1010 is executed.

In the step 1010, it is determined whether a single error is detected, or more than one error is detected.

In case a single error is detected, a step 1012 is executed.

Otherwise, a step 1014 is executed.

In the step 1012, the parity check is executed.

In case the parity check is not successful, the step 1004, is executed to recalculate the checksums.

Otherwise, a step 1016 is executed.

In the step 1016, the error is corrected.

This means, the MAC output computations is corrected at run-time without a stall.

In the step 1014, it is determined whether multiple errors exist in more crossbars' columns belonging to different PEs.

If the multiple errors exist in one PE, the step 1012 is executed.

Otherwise, a step 1018 is executed.

In the step 1018, it is determined, if the method has reached the number of stalls. If the method has reached the number of stalls, the step 1002 is executed to recomputer the MAC outputs. Otherwise, the step 1004 is executed to recompute the checksums without recomputing the MAC outputs.

This means, the method stalls for the MAC output computations if the number of stalls is reached.

The number of columns that are used for the checksum in one PE may vary because the number of columns depends on the number of states that one single memory cell can represent in the crossbar.

According to an example, the original crossbar represents the following values of the MAC output:
1
4
7
3

In case each memory cell can represent only 2 binary states (0 or 1), the crossbar will be at least composed by 3 columns, each column representing the bit significance of the value, and 4 rows, each row representing different weights:

| | | | | |
|---|---|---|---|---|
| 1 | will be mapped as => | 0 | 0 | 1 |
| 4 | will be mapped as => | 1 | 0 | 0 |
| 7 | will be mapped as => | 1 | 1 | 1 |
| 3 | will be mapped as => | 0 | 1 | 1 |

Assuming, un this case, that all 3 columns are protected by the checksum, each row of the checksum will have to map a maximum value of 3, i.e., 7=>1 1 1=>1+1+1=3=1 1 in binary.

Consequently, in this case, the checksum is composed of 2 columns:

| | | |
|---|---|---|
| 1 = 1 => | 0 | 1 |
| 4 = 1 => | 0 | 1 |
| 7 = 3 => | 1 | 1 |
| 3 = 2 => | 1 | 0 |

In case each memory cell represents 4 states, e.g., “00, 01,10,11”, the number of columns of checksum is just 1.

The parity column is actually a similar concept to the single column checksum, but its purpose is different. The parity column is not used for correction, it is used only to further check if the values output of the checksums are actually consistent or not. According to an example, the parity column represents only the least significant bit of the checksum and is just one column.

Assuming, that the values described above are not from the MAC output but from the checksum, the parity column would be:
1
1
1
0

What is claimed is:

1. A device for error detection and/or error correction, in in-memory computations with a set of memory cells for determining a result of a linear operation, each respective memory cell in the set of memory cells includes a respective resistance, the device comprising:
the set of memory cells; and
at least one memory cell configured to determine a checksum that includes a resistance that is the same or essentially the same as a sum of the respective resistances of the set of memory cells.

2. The device according to claim 1, further comprising:
a processing element, wherein the processing element includes the set of memory cells and the at least one memory cell configured to determine the checksum.

3. The device according to claim 1, wherein the resistances of the memory cells of the set of memory cells and the at least one memory cell configured to determine the checksum each connect on one side of the respective resistance to a common input wire, and with the other side of the respective resistance to different output wires.

4. The device according to claim 1, further comprising:
a set of processing elements, wherein the at least one memory cell configured to determine the checksum is arranged in a different processing element of the set of processing elements than the set of memory cells.

5. The device according to claim 4, wherein each of the respective resistances of the memory cells of the set of memory cells connect on one side of the respective resistance to a common output wire, and on the other side of the respective resistance to different input wires.

6. The device according to claim 4, wherein each of the respective resistances of the memory cells of the set of memory cells connect on one side of the respective resistance to a common output wire, and on the other side of the respective resistance to a common input wire.

7. The device according to claim 1, further comprising:
a controller configured to compare an output of the set of memory cells to the checksum, and to detect an error when the output and the checksum differ, wherein the device (is configured to provide the output and the checksum to the controller.

8. The device according to claim 7, further comprising:
a controller configured to add a difference between the output and the checksum to the output, when the error is detected.

9. The device according to claim 1, further comprising:
a processing element with a first part of a crossbar that includes memory cells, and a processing element with a second part of the crossbar that includes memory cells, wherein a first memory cell of the set of memory cells is arranged in the first part of the crossbar, wherein a second memory cell of the set of memory cells is arranged in the second part of the crossbar, wherein the device further comprises an output adder configured to add the output of the first memory cell and the second memory cell to the output of the set of memory cells.

10. The device according to claim 1, further comprising:
a processing element with a part of a first crossbar that includes memory cells, and a processing element with a part of a second crossbar that includes memory cells, wherein a first memory cell of the set of memory cells is arranged in the part of the first crossbar, wherein a second memory cell of the set of memory cells is arranged in the part of the second crossbar, wherein the device further comprises an input adder configured to add the input of the crossbars to an input for the memory cell configured to determine the checksum, and to provide the input to the memory cell configured to determine the checksum.

11. The device according to claim 1, wherein the set of memory cells and the at least one memory cell configured to determine the checksum are arranged in an arrangement of memory cells that includes a processing element that includes the set of memory cells and the at least one memory cell configured to determine the checksum, and a set of processing elements, and a further set of memory cells, and at least one further memory cell configured to determine a checksum for the further set of memory cells, wherein the at least one further memory cell is arranged in a different processing element of the set of processing elements than the further set of memory cells.

12. The device according to claim 1, wherein the device further comprises memory cells for determining two redundant checksums, and a memory cell for a parity check of the two redundant checksums, wherein the memory cell for determining the parity check includes a resistance that is the same as a sum of the respective resistances of the memory cells that provide a least significant bits of the two redundant checksums.

13. A method for error detection and/or error correction, in in-memory computations with a set of memory cells for determining a result of a linear operation, wherein each respective memory cell in the set of memory cells includes a respective resistance, the method comprising the following steps:
providing at least one memory cell configured to determining a checksum, that includes a resistance that is the same or essentially the same as a sum of the respective resistances;
determining an output of the set of memory cells and providing an input to the at least one memory cell configured to determine the checksum;
comparing the output to the checksum; and
detecting an error when the output and the checksum differ.

14. The method according to claim 13, further comprising:
determining a respective output of each respective memory cell of the set of memory cells and the checksum resulting from providing the same input to the memory cells of the set of memory cells and the at least one memory cell configured to determine the checksum; and
adding the respective output of the respective memory cells of the set of memory cells to the output.

15. The method according to claim 13, further comprising:
providing the memory cells of the set of memory cells with a respective voltage for determining a respective output of each respective memory cell of the set of memory cells;
adding the respective output to the output;
adding the respective input to the input for the at least one memory cell configured to determine the checksum; and
providing the input to the memory cell configured to determine the checksum.

16. The method according to claim 13, wherein, for error correction, a difference between the checksum and the output is added to the output, when the error is detected.

17. The method according to claim 13, wherein a first memory cell of the set of memory cells is associated with a first part of a crossbar in a first processing element, wherein a second memory cell of the set of memory cells is associated with a second part of the crossbar in a second processing element, wherein an output of the first memory cell and the second memory cell are added in the output of the set of memory cells.

18. The method according to claim 13, wherein a first memory cell of the set of memory cells is associated with a part of a first crossbar in a first processing element, wherein a second memory cell of the set of memory cells is associated with a part of a second crossbar in a second processing element, wherein an input of the first and second crossbars are added to the input for the at least one memory cell configured to determine the checksum.

19. The method according to claim 13, further comprising:
checking a parity of memory cells for determining two redundant checksums, with a memory cell for a parity check of the two redundant checksums, wherein the memory cell for determining the parity check includes a resistance that is the same as a sum of resistances of the memory cells that provide least significant bits of the two redundant checksums;
recomputing the checksums when the parity check fails, and correcting an error indicated by the two redundant checksums otherwise.
